(19) United States
(12) Patent Application Publication
(10) Pub. No.: US 2022/0348205 A1
(43) Pub. Date: Nov. 3, 2022

(54) Compression-Based Speed Limitation For A Driveline Including A Transmission

(71) Applicant: TRANSMISSION CVTCORP INC., Sainte-Julie (CA)

(72) Inventors: Jonathan Guérin, Sainte-Julie (CA); Jean-Philippe Parent, Mont St-Hilaire (CA)

(73) Assignee: TRANSMISSION CVTCORP INC., Sainte-Julie (CA)

(21) Appl. No.: 17/734,289

(22) Filed: May 2, 2022

Related U.S. Application Data
(60) Provisional application No. 63/183,099, filed on May 3, 2021.

(51) Int. Cl. B60W 30/184; B60W 10/101; B60W 10/06; B60W 50/12; F16H 61/66; F16H 59/40; F16H 63/50; F16H 59/42

(52) U.S. Cl. CPC B60W 30/184; B60W 10/101; B60W 10/06; B60W 50/12; F16H 61/66; F16H 59/40; F16H 63/50; F16H 59/42; B60W 2510/104; B60W 2710/1005; B60W 2710/0683; B60W 2540/10; B60W 2552/15; B60W 2510/1015

(57) ABSTRACT

A compression-based speed limiting for a driveline including a transmission is described herein. The driveline controller detects over speeding and controls the ratio of the transmission to therefore increase compression of the prime mover and therefore limit speed.

### CROSS-REFERENCE TO RELATED APPLICATION

The present application claims the benefit of the filing date of U.S. Provisional patent application No. 63/183,009 filed May 3, 2021, the disclosure of which is hereby incorporated herein by reference.

### FIELD

The present disclosure generally relates to drivelines including a transmission. More specifically, the present disclosure is concerned with compression-based speed limitation for such a driveline.

### BACKGROUND

Some off-road vehicles need to go downhill for long stretches of time. Examples of these vehicles include mining vehicles that have to go down in mines. These long stretches of downhill travel have a negative impact on the brakes of these vehicles that may overheat which decreases their lifespan.

One conventional method of mitigating the premature wear and decreased lifespan of such a vehicle braking system is to downshift the transmission of the vehicle and use the engine compression to decrease the downhill speed to therefore decrease the use of the brakes. This method is somewhat inefficient and relies on the driver to control the discrete transmission ratio. The inefficiency of this conventional method is that with conventional discrete transmission, the driver must engage the gear that does not provided too much engine compression, but it does not mean that this chosen gear provides enough compression, leading to the required use of the brakes.

### BRIEF DESCRIPTION OF THE DRAWINGS

In the appended drawings:

FIG. 1 is a block diagram of a driveline including a transmission according to a first illustrative embodiment; and

FIG. 2 is a block diagram of a driveline including a transmission according to a second illustrative embodiment.

### DETAILED DESCRIPTION

An object is generally to provide an improved driveline including using compression-based speed limiting.

More specifically, according to an illustrative embodiment, there is provided a driveline comprising:

a prime mover having an output shaft;

a transmission having an input connected with the output shaft of the prime mover and an output; and

a controller connected with both the prime mover and the transmission; the controller being so configured as to detect over speeding of the transmission output and to decrease the transmission ratio to thereby force an increase of the prime mover compression to thereby limit the speed of the transmission output when over speeding is detected.

According to another aspect, there is provided a driveline provided between a prime mover having an output shaft and a load, the driveline comprising:

a transmission having an input connected with the output shaft of the prime mover and an output associated with the load; and

a controller connected with both the prime mover and the transmission; the controller being so configured as to detect over speeding of the transmission output and to decrease the transmission ratio to thereby force an increase of the prime mover compression to thereby limit the speed of the transmission output when over speeding is detected. The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The expression “connected” should be construed herein and in the appended claims broadly so as to include any cooperative or passive association between mechanical parts or components. For example, such parts may be assembled together by direct connection, or indirectly connected using further parts therebetween. The connection can also be remote, using for example a magnetic field or else.

The term “about” is used to indicate that a value includes an inherent variation of error for the device or the method being employed to determine the value.

It is to be noted that the expression “prime mover” is to be construed herein and in the appended claims as an internal combustion engine (ICE), a turbine engine, or any other mechanical power production element or assembly.

It is to be noted that the term “CVT”, standing for Continuously Variable Transmission, is used herein to describe any type of CVT including, amongst others, a toroidal CVT, a dual-cavity full toroidal CVT, a half-toroidal CVT, a single cavity toroidal CVT, a hydrostatic CVT, a Variable diameter pulley CVT, a magnetic CVT, a ratcheting CVT and a cone CVT.

It is to be noted that the expression “overdrive” when used in the context of a CVT, is to be construed herein and in the appended claims as a condition where the CVT ratio is such that the CVT output speed is higher than the CVT input speed. The CVT ratio (of output speed to input speed) is therefore higher that one to one (1:1).

It is to be noted that the expression “underdrive” when used in the context of a CVT, is to be construed herein and in the appended claims as a condition where the CVT ratio is such that the CVT output speed is lower than the CVT input speed. The CVT ratio (of output speed to input speed) is therefore lower that one to one (1:1).

It is to be noted that the term “driveline”, used herein and in the appended claims, is to be construed as the intervening mechanism by which power is transmitted from a prime mover to a load, for example the wheels of a vehicle, as well as this mechanism plus the prime mover.

It is to be noted that the expression “off-highway vehicle” is to be construed herein and in the appended claims as any type of vehicle that is designed specifically for use off-road, including, amongst others, construction vehicles and agricultural vehicles.

It is also to be noted that the term “over speeding” is to be construes herein and in the appended claims as a speed that is higher than a threshold that may be fixed or variable according to vehicle parameters such as the position of the acceleration pedal, for example.

Other objects, advantages and features of the compression-based speed limitation for a driveline including a transmission will become more apparent upon reading of the following non-restrictive description of illustrative embodiments thereof, given by way of example only with reference to the accompanying drawings.

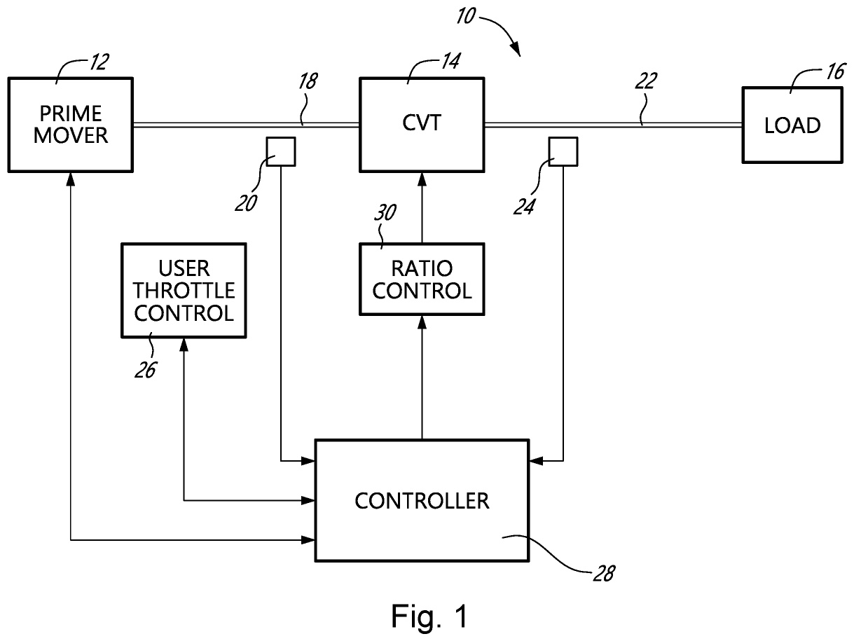

FIG. 1 of the appended drawings illustrate a driveline 10 according to a first illustrative embodiment comprising a prime mover 12, in the form of an ICE, and a transmission in the form of a CVT 14. The output of the transmission 14 is connected to a load 16, for example wheels of an off-road vehicle.

A first shaft 18 interconnects the output of the ICE 12 and the input of the CVT 14; the speed of the first shaft is measured via a first speed sensor 20. A second shaft 22 interconnects the output of the CVT 14 and the load 16; the speed of the second shaft 26 is measured via a second speed sensor 24.

Conventionally, a user throttle control 26, for example an acceleration pedal (not shown) is associated with the prime mover 12. Instead of being directly connected to the throttle input of the prime mover 12, the user throttle 26 is connected to a controller 28 to supply throttle data thereto. The controller 28 may therefore supply throttle data to the prime mover 12, in its original form or in a clipped form, as will be discussed hereinbelow.

The driveline 10 also includes a ratio controller 30 so configured as to set the ratio of the CVT 14 according to a ratio value provided by the main controller 28 as will be described hereinbelow.

One skilled in the art will understand that the bloc diagram of FIG. 1 is schematic and that many other elements, required for the operation of the driveline 10 have been omitted therefrom. As a non-limiting example, a clutch is often provided between the prime mover and the transmission.

The speed data from the first and second speed sensors 20 and 24 is supplied to the main controller 28 so that the controller 28 may determine the actual ratio of the transmission 14 in real time.

As will be easily understood by one skilled in the art, the main controller 28 could integrate the ratio controller 38.

When a driveline such as 10 is installed in an off-road vehicle that often needs to go downhill for long stretches of time, the controller 28 is so configured as to control the ratio of the CVT 14 so as to optimize the compression of the prime mover 12 and therefore to minimize the use of the brakes (not shown).

More specifically, since the controller 28 receives throttle data from the acceleration pedal 26, the controller 28 knows the position of the pedal 26. Accordingly, a speed limitation based on the position of the acceleration pedal 26 can be implemented by the controller 28.

As a non-limiting example, the speed limit can be 42 km/h when the pedal 26 is totally depressed, 20 km/h when the pedal 26 is not depressed and can vary linearly between these two extreme positions. One skilled in the art will understand that the controller 28, by receiving speed data relating to the output of the transmission 14 from the speed sensor 24, and by knowing the characteristics of the off-highway vehicle, can determine the ground speed of the vehicle from the speed data from the speed sensor 24.

The controller 28 has mainly two ways of maintaining the speed limit, i.e. preventing over speeding at the output of the transmission 14: it can clip the user throttle control to the prime mover 12 and it can decrease the ratio of the transmission 14. Both of these ways are generally used sequentially. The signal is clipped and should the speed be still too high, the transmission ratio is decreased. Of course, both the signal clipping and the decrease of the transmission ratio can be done simultaneously.

In the first illustrative embodiment illustrated in FIG. 1, when the vehicle travels downhill and the acceleration pedal 26 is not depressed, the controller 28 attempts to prevent over speeding by limiting the speed to 20 km/h by decreasing the ratio of the transmission 14 to thereby increase the compression of the prime mover 12.

Indeed, by controlling the CVT ratio towards the underdrive, the downhill movement of the vehicle tries to speed up the shaft 18 of the prime mover 12, which increases the compression of the prime mover 12, preventing the vehicle from speeding up therefore preventing the downhill speed limit to be overshot. The controller 28 may thus control the maximum speed of the vehicle by finely controlling the ratio of the CVT 14 depending on the vehicle ground speed detected, for example via the speed sensor 24.

Of course, as mentioned hereinabove, the controller 28 also sets the signal sent to the throttle input of the prime mover so as to promote compression thereof.

One skilled in the art will understand that in this first illustrative embodiment, when the driver changes the position of the acceleration pedal the controller 28 adapts the speed limit to the position of the acceleration pedal.

Furthermore, one skilled in the art will understand that should the driver of the vehicle decide to depress the acceleration pedal 26 during downhill travel, the vehicle will accelerate.

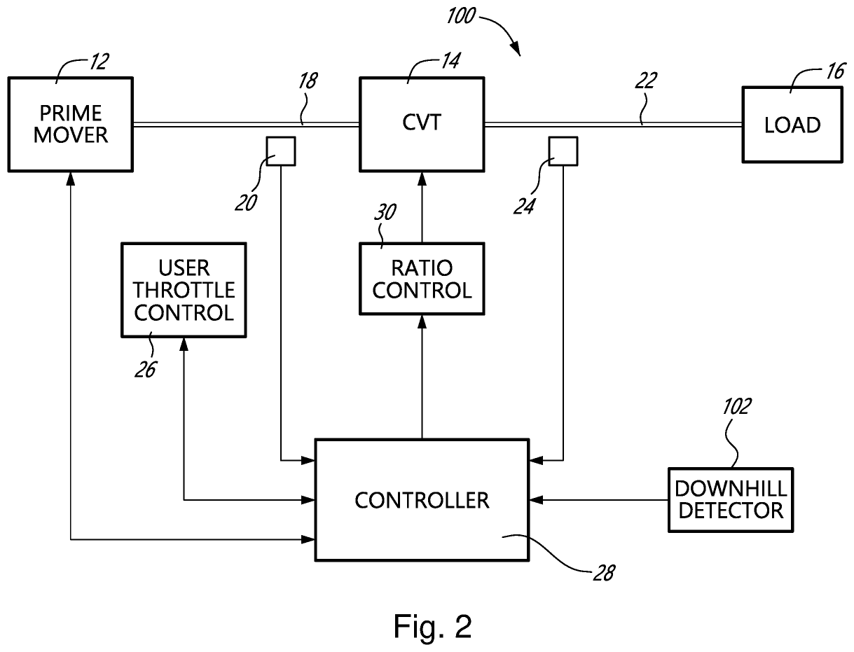

In a second illustrative embodiment, shown in FIG. 2, the driveline 100 further includes a downhill detector 102 that is connected to the controller 28.

The use of a downhill detector 102 makes it possible to totally ignore the position of the acceleration pedal 26 during downhill travel. Accordingly, the speed limit features could be identical to the speed limit features described hereinabove with respect to FIG. 1 when the downhill detector 102 does not detect downhill travel and could be 20 km/h (for example) when downhill travel is detected by the downhill detector 102.

In other words, when such a downhill detector 102 is used, the controller 28 enters in the speed limiting mode when the downhill detector 102 detects downhill travel, without the need for the acceleration pedal 26 to be released. It is interesting since it allows the downhill speed to be limited even though a careless or distracted driver may still depress the acceleration pedal 26 while travelling downhill.

As non-limiting examples, altimeters, inclinometers, GPS and maps, manual selector, proximity beacons and/or extended brake-use detectors can be used as a downhill detector 102 to determine if the vehicle travels downhill.

While the transmission 14 has been described hereinabove as being a continuously variable transmission, one skilled in the art will understand that any multi-speed transmission that can be controlled electronically could be used and that the efficiency of the system described herein generally increases with the number of transmission ratios available.

As will easily be understood by one skilled in the art, the various speed sensors shown herein as discrete elements, could be integrated with other elements. As non-limiting examples, the speed sensor 20 could be integrated with the prime mover 12, or both the speed sensors 20 and 24 could be integrated in the CVT 14.

It is to be understood that the compression-based speed limitation for a driveline including a transmission is not limited in its application to the details of construction and parts illustrated in the accompanying drawings and described hereinabove. The compression-based speed limitation for a driveline including a transmission is capable of other embodiments and of being practiced in various ways. It is also to be understood that the phraseology or terminology used herein is for the purpose of description and not limitation. Hence, although the compression-based speed limitation for a driveline including a transmission has been described hereinabove by way of illustrative embodiments thereof, it can be modified, without departing from the spirit, scope and nature thereof.

What is claimed is:

1. A driveline comprising:
a prime mover having an output shaft;
a transmission having an input connected with the output shaft of the prime mover and an output; and
a controller connected with both the prime mover and the transmission; the controller being so configured as to detect over speeding of the transmission output and to decrease the transmission ratio to thereby force an increase of the prime mover compression to thereby limit the speed of the transmission output when over speeding is detected.

2. The driveline as recited in claim 1 wherein the transmission is a continuously variable transmission.

3. The driveline as recited in claim 2, further comprising a ratio controller connected to both the continually variable transmission and to the controller, the ratio controller being so configured as to set the ratio of the continually variable transmission according to a ratio value received from the controller.

4. The driveline as recited in claim 2, further comprising a first speed sensor sensing the speed of the input of the continually variable transmission and a second speed sensor sensing the speed of the output of the continually variable transmission; speed data from the first and second speed sensors being supplied to the controller to allow the controller to monitor the actual speed ratio of the continually variable transmission in real time.

5. The driveline as recited in claim 4, wherein the first and second speed sensor are integrated with the continually variable transmission.

6. The driveline as recited in claim 1, further comprising a user throttle control connected to both the controller and the prime mover; the controller being further configured so as to clip a throttle signal supplied to the prime mover should over speeding of the output shaft of the transmission be detected.

7. The driveline as recited in claim 6, wherein the controller determines a maximal speed threshold according to a position of the user throttle control.

8. The driveline as recited in claim 1, further comprising a downhill detector supplying downhill travelling data to the controller; the controller being so configured as to limit the speed of the transmission output to a predetermined threshold when downhill travelling is detected.

9. A driveline provided between a prime mover having an output shaft and a load, the driveline comprising:
a transmission having an input connected with the output shaft of the prime mover and an output associated with the load; and
a controller connected with both the prime mover and the transmission; the controller being so configured as to detect over speeding of the transmission output and to decrease the transmission ratio to thereby force an increase of the prime mover compression to thereby limit the speed of the transmission output when over speeding is detected.

10. The driveline as recited in claim 9 wherein the transmission is a continuously variable transmission.

11. The driveline as recited in claim 10, further comprising a ratio controller connected to both the continually variable transmission and to the controller, the ratio controller being so configured as to set the ratio of the continually variable transmission according to a ratio value received from the controller.

12. The driveline as recited in claim 10, further comprising a first speed sensor sensing the speed of the input of the continually variable transmission and a second speed sensor sensing the speed of the output of the continually variable transmission; speed data from the first and second speed sensors being supplied to the controller to allow the controller to monitor the actual speed ratio of the continually variable transmission in real time.

13. The driveline as recited in claim 12, wherein the first and second speed sensor are integrated with the continually variable transmission.

14. The driveline as recited in claim 9, further comprising a user throttle control connected to both the controller and the prime mover; the controller being further configured so as to clip a throttle signal supplied to the prime mover should over speeding of the output shaft of the transmission be detected.

15. The driveline as recited in claim 14, wherein the controller determines a maximal speed threshold according to a position of the user throttle control.

16. The driveline as recited in claim 9, further comprising a downhill detector supplying downhill travelling data to the controller; the controller being so configured as to limit the speed of the transmission output to a predetermined threshold when downhill travelling is detected.
